(19) United States
(12) Patent Application Publication
(10) Pub. No.: US 2015/0325893 A1
(43) Pub. Date: Nov. 12, 2015

(54) HEAT RETAINING VEHICLE BATTERY ASSEMBLY

(71) Applicant: FORD GLOBAL TECHNOLOGIES, LLC, Dearborn, MI (US)

(72) Inventors: Neil Robert BURROWS, White Lake Township, MI (US); Sydney BERRY, Dearborn, MI (US); John Paul GIBEAU, Canton, MI (US)

(73) Assignee: FORD GLOBAL TECHNOLOGIES, LLC, Dearborn, MI (US)

(21) Appl. No.: 14/270,488

(22) Filed: May 6, 2014

(51) Int. Cl. H01M 10/658

(52) U.S. Cl. CPC H01M 10/658; H01M 10/615; H01M 10/625; H01M 10/6554; H01M 2220/20

(57) ABSTRACT

A traction battery assembly includes a battery stack having a first cell defining one end of the stack. An endplate is disposed proximate the first cell. An insulator body is disposed between the endplate and the first cell. The insulator body thermally insulates the first cell from the endplate to reduce dissipation of cell-generated heat and to facilitate cell stack warm up in cold conditions. The traction battery assembly may also include a heating element to provide thermal energy to the cell stack.

### TECHNICAL FIELD

This disclosure relates to the thermal management of battery cells in electric vehicles.

### BACKGROUND

Vehicles such as battery-electric vehicles (BEVs), plug-in hybrid electric vehicles (PHEVs) or full hybrid-electric vehicles (FHEVs) contain a battery, such as a high voltage battery, to act as an energy source for the vehicle. Battery capacity, operation and cycle life can change depending on the operating temperature of the battery. It is generally desirable to maintain the battery within a specified temperature range while the vehicle is operating or while the vehicle is charging.

Vehicles with batteries may include thermal management systems to provide temperature control for the batteries to extend life and improve performance.

### SUMMARY

In one embodiment, a traction battery assembly includes a battery stack having a first cell defining one end of the stack. An endplate is disposed proximate to the first cell. An insulator body is disposed between the endplate and the first cell. The insulator body thermally insulates the first cell from the endplate to reduce dissipation of cell-generated heat and to facilitate cell stack warm up in cold conditions.

In another embodiment, a traction battery assembly includes a plurality of battery cells defining a battery stack. A pair of endplates are disposed against opposing ends of the stack and are configured to apply compression to secure the stack together. A pair of insulator bodies are disposed against opposite sides of the stack between an outer cell of the stack and one of the endplates to thermally insulate stack from the endplate to reduce dissipation of cell-generated heat and to facilitate cell stack warm up in cold conditions.

In yet another embodiment, a traction battery assembly includes a battery stack having a first cell defining one end of the stack and an endplate disposed proximate the first cell. A heating element is disposed adjacent to a major surface of the first cell to provide thermal energy to the battery stack.

### BRIEF DESCRIPTION OF THE DRAWINGS

FIG. 1 illustrates a schematic of a typical plug-in hybrid-electric vehicle.

FIG. 2 illustrates a bar graph depicting cell temperatures during a battery warm up test.

FIG. 3 illustrates a line graph depicting cell temperatures during a battery warm up test.

FIG. 4 illustrates a side view of a battery assembly.

FIG. 5 illustrates an exploded side view of another battery assembly.

FIG. 6 illustrates an exploded side view of yet another battery assembly.

FIG. 7 illustrates a heating element.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

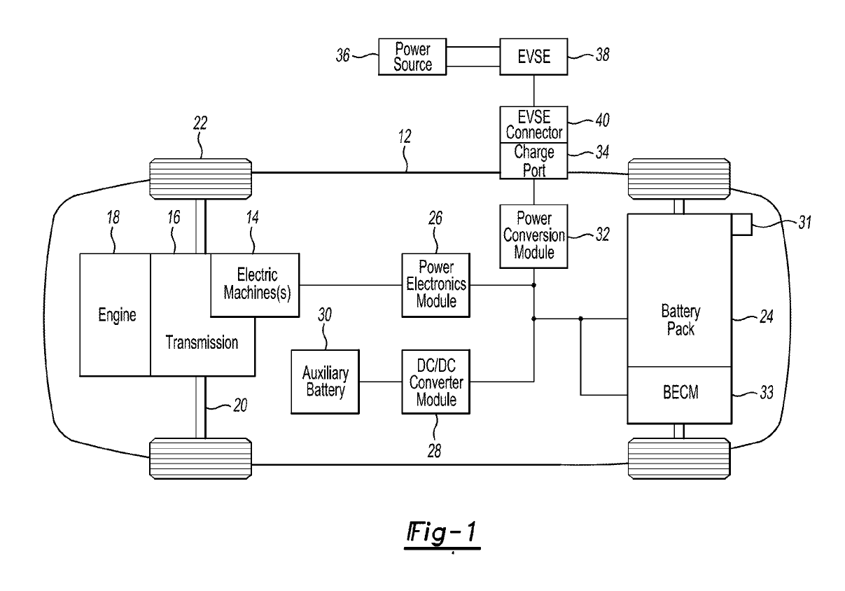

FIG. 1 depicts a schematic of a typical plug-in hybrid-electric vehicle (PHEV). The vehicle 12 includes one or more electric machines 14 mechanically connected to a hybrid transmission 16. The electric machines 14 may be capable of operating as a motor or a generator. In addition, the hybrid transmission 16 is mechanically connected to an engine 18. The hybrid transmission 16 is also mechanically connected to a drive shaft 20 that is mechanically connected to the wheels 22. The electric machines 14 can provide propulsion and deceleration capability when the engine 18 is turned on or off. The electric machines 14 also act as generators and can provide fuel economy benefits by recovering energy through regenerative braking. The electric machines 14 reduce pollutant emissions and increase fuel economy by reducing the work load of the engine 18.

A traction battery or battery pack 24 stores energy that can be used by the electric machines 14. The traction battery 24 typically provides a high voltage direct current (DC) output from one or more battery cell arrays, sometimes referred to as battery cell stacks, within the traction battery 24. The battery cell arrays may include one or more battery cells. The traction battery 24 is electrically connected to one or more power electronics modules 26 through one or more contactors (not shown). The one or more contactors isolate the traction battery 24 from other components when opened and connect the traction battery 24 to other components when closed. The power electronics module 26 is also electrically connected to the electric machines 14 and provides the ability to bi-directionally transfer electrical energy between the traction battery 24 and the electric machines 14. For example, a typical traction battery 24 may provide a DC voltage while the electric machines 14 may require a three-phase alternating current (AC) voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the traction battery 24. The description herein is equally applicable to a pure electric vehicle. In a pure electric vehicle, the hybrid transmission 16 may be a gear box connected to an electric machine 14 and the engine 18 is not present.

In addition to providing energy for propulsion, the traction battery 24 may provide energy for other vehicle electrical systems. A typical system may include a DC/DC converter module 28 that converts the high voltage DC output of the traction battery 24 to a low voltage DC supply that is compatible with other vehicle loads. Other high-voltage loads, such as compressors and electric heaters, may be connected directly to the high-voltage without the use of a DC/DC converter module 28. In a typical vehicle, the low-voltage systems are electrically connected to an auxiliary battery 30 (e.g., 12 V battery).

A battery electrical control module (BECM) 33 may be in communication with the traction battery 24. The BECM 33 may act as a controller for the traction battery 24 and may also include an electronic monitoring system that manages temperature and charge state of each of the battery cells. The traction battery 24 may have a temperature sensor 31 such as a thermistor or other temperature gauge. The temperature sensor 31 may be in communication with the BECM 33 to provide temperature data regarding the traction battery 24.

The vehicle 12 may be recharged by an external power source 36. The external power source 36 is a connection to an electrical outlet. The external power source 36 may be electrically connected to electric vehicle supply equipment (EVSE) 38. The EVSE 38 may provide circuitry and controls to regulate and manage the transfer of electrical energy between the power source 36 and the vehicle 12. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The EVSE connector 40 may have pins that mate with corresponding recesses of the charge port 34.

The various components discussed may have one or more associated controllers to control and monitor the operation of the components. The controllers may communicate via a serial bus (e.g., Controller Area Network (CAN)) or via discrete conductors.

The battery cells, such as a prismatic or pouch cell, may include electrochemical cells that convert stored chemical energy to electrical energy. The cells may include a housing, a positive electrode (cathode) and a negative electrode (anode). An electrolyte may allow ions to move between the anode and cathode during discharge, and then return during recharge. Terminals may allow current to flow out of the cell for use by the vehicle. When positioned in an array with multiple battery cells, the terminals of each battery cell may be aligned with opposing terminals (positive and negative) adjacent to one another and a busbar may assist in facilitating a series connection between the multiple battery cells. The battery cells may also be arranged in parallel such that similar terminals (positive and positive or negative and negative) are adjacent to one another. For example, two battery cells may be arranged with positive terminals adjacent to one another, and the next two cells may be arranged with negative terminals adjacent to one another. In this example, the busbar may contact terminals of all four cells.

The BECM or other controller may be programmed to operate the battery cells in a plurality of operating states based on operating conditions. For example, the battery controller is programed to operate the battery cells in a power limiting state. Operating the battery cells in a power limiting state is necessary when the cells are below a certain threshold temperature. For example, if the cells are below 0° C., the cells are in a power limiting state. If the cell temperatures are above that threshold, the cells operate at a normal operating state. The battery controller may be programmed to have several different power limiting states depending upon the temperature of the cells. The controller may be programed to increase the power level at certain critical temperature points. For example, if the cells are below the −30° C. critical point, the battery cells are limited to 25 amps (A), if the battery cells are below the −25° C. critical point the cells are limited to 35 A, and if the cells are below the −15° C. critical point the cells are limited to 45 A.

Moving from a lower power limiting state to a higher power limiting state requires all of the cells obtain the minimum temperature for that power state. Testing shows that the cells do not uniformly increase in temperature. Rather, the inner cells increase in temperature faster than the outermost cells. This is due to the outermost cells losing heat through the endplates to the outside environment.

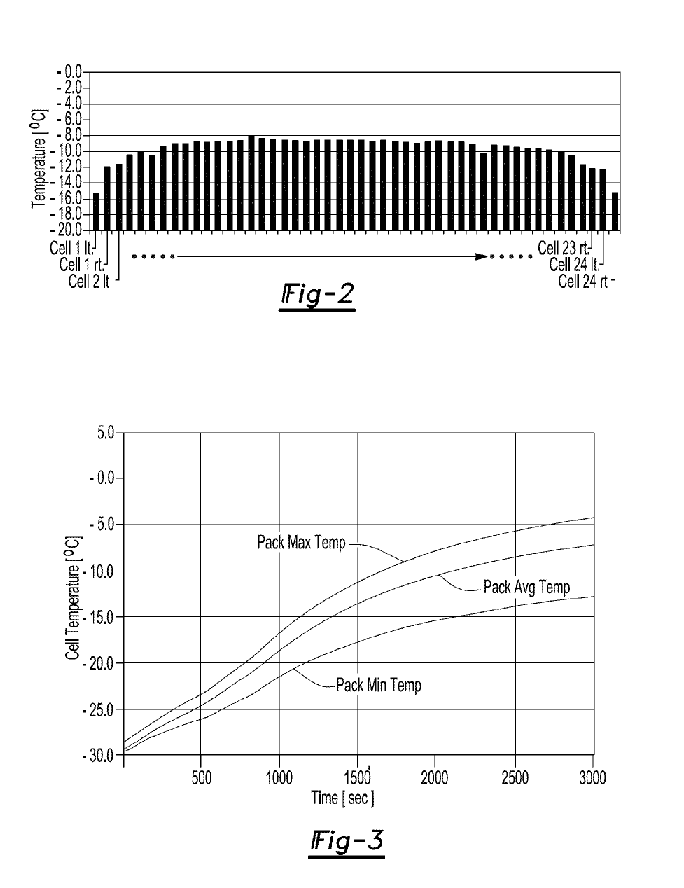

FIG. 2 illustrates cell temperature during a battery warm-up test. The battery assembly tested comprised a plurality of prismatic cells stacked in a battery array. The temperature of each cell was measured at two locations. A first temperature measurement was taken for the left side of each cell and a second temperature measurement was taken for the right side of each cell. (Note: the left side and right side refers to the opposing large sides of the cell that are disposed against the other cells. Thus, cell 1 left is adjacent to the endplate and cell 1 right is adjacent to cell 2 left.) The initial temperature of all of the cells was −30° C. (ambient air temperature). The cells were cycled at various power states to simulate cell operation and the temperature of each cell was individually measured. The bar graph illustrates these temperature measurements. Each temperature measurement has its own bar. The first bar illustrates the temperature of the left side of cell one (labeled cell 1 lt.), the second bar illustrates the temperature of the right side (labeled cell 1 rt.) and so forth along the stack. The test was preformed until the temperature of all of the cells exceeded the threshold temperature for normal operation.

Cells 4 to 21 have a generally uniform temperature. The average temperature of cells 4 to 21 is −8.7° C. The outer most cells (cells 1 and 24) however, are drastically colder than the interior cells. The average temperature of the outer most cells is −13.5° C. This is 4.8° C. less than the average temperature of cells 4 to 21. The outer sides of cells 1 and 24 are significantly colder than the inner sides. Cell 1 left has a temperature of −15.3° C. and cell 1 right has a temperature of −12.0° C. Thus, it is clear that the outer most cells are losing significantly more heat to the outside air than the other cells. The lagging temperatures of the outermost cells cause the battery to remain in the power limiting state longer. Battery cells operating in the power limited state generate less heat due to lower current levels in the cells. The outer cell lagging temperatures keep the inner cells operating at a reduced current level and retard the ability of the inner cells to operate at a higher current level and generate more heat. This effect further contributes to slower cell temperature warm up.

FIG. 3 illustrates the maximum temperature, the minimum temperature and the average temperature of the battery array at different times during the battery warm-up test. (Note:

FIGS. 2 and 3 are data taken from the same battery test.) The test data shows that the difference between the time when the average battery temperature reaches a critical temperature point and the time the minimum temperature reaches that same point is on the magnitude of minutes, for each critical point. The difference between the average and minimum temperatures increased as time increased. The outer most cells (which are indicated as the pack min temp) took about 3 minutes longer to reach −25° C. than did the average cell temperature. Worst yet, the outermost cells took about 10 minutes longer to reach −15° C. than did the average cell. Thus, the faster all the cells in the array are able to warm up in cold conditions, the less time spent in a power limiting state increasing overall performance capabilities of the battery. In order to achieve a quicker warm-up, the negative affect of the heat transfer between the outer most cell and the ambient air needs to be addressed.

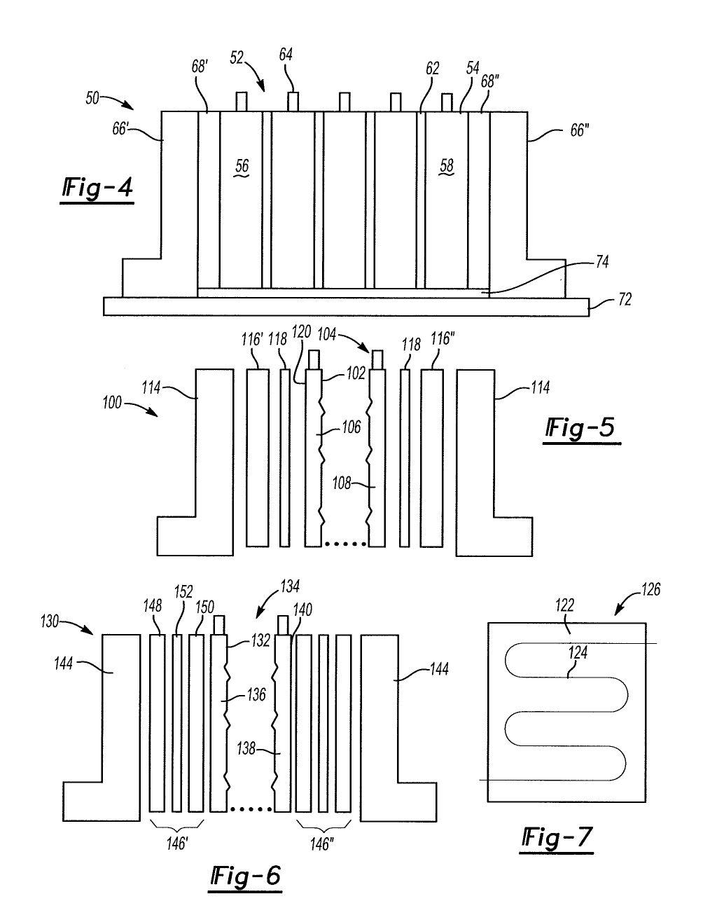

FIG. 4 illustrates a cross-section view of a battery assembly 50. The battery assembly 50 includes a plurality of battery cells 54 defining a battery stack 52. The battery stack 52 has a first outer cell 56 and a second outer cell 58. The first and second outer cells 56, 58 define the ends of the stack 52. A plurality of spacers 62 are disposed within the stack between the cells 54. Each cell 54 includes at least one terminal 64. The terminals 64 are interconnected by bussing (not shown) to electrically connect the cells 54 in series or parallel. A pair of endplates 66 are disposed at each end of the stack 52 and sandwich the stack. A first endplate 66′ is disposed proximate to the first outer cell 56 and a second endplate 66″ is disposed proximate to the second outer cell 58. The endplates 66 cooperate to provide compression to the opposing ends of the stack 52 and secure the stack together. The endplates 66 are interconnected with side rails (not shown).

The battery assembly 50 also includes a pair of insulator bodies 68. The first insulator body 68′ is disposed between the first endplate 66′ and the first cell 56. The second insulator body 68″ is disposed between the second endplate 66″ and the second cell 58. The insulator bodies 68 thermally insulate the cells from the endplates to reduce dissipation of cell-generated heat to the outside environment and to facilitate stack warm up in cold conditions. The insulating bodies 68 provide the most benefit to the outermost cells. Unlike the battery assembly tested in the battery warm-up test (test data shown in FIGS. 2 and 3), battery assemblies including insulator bodies provide more uniform temperatures across all of the cells in the stack. By reducing the temperature lag between the outer cells and the interior cells the battery can operate in a power limiting state for a shorter amount of time. This increases the performance and fuel economy of the vehicle and provides a better driving experience for the operator.

The stack 52, the endplates 66, and the insulator bodies 68, when combined, generally form a battery array. One or more battery arrays are included in the battery assembly. (Note: Battery assembly 50, shown in FIG. 4, only includes one battery array.) The battery assembly 50 includes a substrate 72. The one or more battery arrays are attached to the substrate 72. The substrate 72 may be a thermal plate that is configured to provide heating and/or cooling to the battery array. An optional thermal interface material (TIM) 74 is disposed between the battery stack 52 and the substrate 72. The TIM is a compressible material that absorbs cells height variation between the cells to reduce gaps between the cells and the thermal plate 72. This provides improved thermal conductivity between the cells and the thermal plate 72.

The insulator body 68 may be made of any suitable material. For example the insulator body 68 may be made of polypropylene, high density polyethylene, polyamide, nylon, polyphenylene oxide or polybutylene terephthalate.

Alternatively, the battery assembly 50 may include insulating endplates. Here, the insulating endplates may cooperate with the insulator bodies 68 to provide increase insulation or the insulator bodies may be omitted. Insulating endplate materials include polyphenylene sulfide and polyacrylonitrile-butadiene styrene.

Referring to FIG. 5, an exploded view of another battery assembly 100 is shown. The battery assembly 100 includes a plurality of battery cells 102 defining a battery stack 104. The battery stack 104 includes a first outer cell 106 and a second outer cell 108 that define the ends of the stack 104. A plurality of interior spacers (not shown) are disposed between the plurality of cells 102. The interior spacers are similar to the interior spacers 62 shown in FIG. 4. A pair of endplates 114 are disposed at each end of the stack 104 and sandwich the stack. The endplates 114 are interconnected with side rails (not shown) and provide compression to secure the stack 104 together.

The battery assembly 100 may include a pair of endplate spacers 116. The first endplates spacer 116′ is disposed between the first outer cell 106 and one of the endplates 114. The second endplate spacer 116″ is disposed between the second outer cell 108 and the other endplate 114. The endplates spacers 116 may be the same as the interior spacers or may be different. For example, the endplates spacers 116 may be thicker than the interior spacers to provide greater thermal insulation. Alternatively, the endplates spacers 116 may be formed of an insulator material. For example, the endplates spacers 116 may be the same as the insulator bodies 68 as previously described above.

The battery assembly 100 also includes a pair of heating elements 118. Each heating element 118 is disposed adjacent to a major surface 120 on one of the first or second outer cells 106, 108. Each heating element 118 may be attached to one of the outer cells 106, 108 or may be attached to one of the endplates spacers 116. For example, the heating element 118 is laminated to one of the outer cells 106, 108.

Alternatively, the end plate spacers 116 and the heating elements 118 may be combined to form a singular component. For example, each heating element 118 may include a thermally conductive surface disposed against the major surface 120 of one of the outer cells 106, 108 and a thermally insulated surface opposite the thermally conductive surface.

The heating elements 118 directly provide heat to the outer cells to reduce the temperature difference between the outer cells and the inner cells. Thus, the outer cells will not lag in temperature as compared to the inner cells, reducing the amount of time the battery pack is in a power limiting state. The heating elements 118 also have the capability of heating the entire stack and not just the outer cells. This decreases the overall time spent in a power limiting state. Using a heating element to warm the cells has several advantages. The heating element can be turned on and off depending upon operating conditions. This provides less strain on the thermal cooling system when the cells have reached warm-up temperatures. Heating elements also provide variable heating, which increases the precision of temperature control.

The heating elements 118 may be a heating film that is laminated to the cells, the endplates spacers, or the endplates. For example, the heating film may be a Kapton heater. FIG. 7 illustrates a typical Kapton heater 126. The Kapton heater 126 includes a plastic film 122 and an electric heating coil 124 disposed with in the film 122. The coil 124 has a relatively high electric resistance and generates heat as electricity passes through the coil 124. Kapton heaters are relatively thin and their addition to the battery array will not cause a significant increase in the size of the battery array.

Referring to FIG. 6, an exploded view of another battery assembly 130 is shown. The battery assembly 130 includes a plurality of battery cells 132 defining a battery stack 134. The battery stack 134 includes a first outer cell 136 and a second outer cell 138 that define the ends 140 of the stack 134. A plurality of interior spaces (not shown) are disposed between the plurality of cells 132. A pair of endplates 144 are disposed proximate to each end 140 of the stack 134 and sandwich the stack.

The battery assembly 130 also includes a pair of endplates spacers 146. The first endplates spacer 146′ is disposed between the first outer cell 136 and one of the endplates 144. The second endplate spacer 146″ is disposed between the second outer cell 138 and one of the endplates 144. Each of the endplates spacers 146 includes a first spacer half 148 that is disposed against one of the endplates 144 and a second spacer half 150 that is disposed against one of the outer cells 136, 138. A heating element 152 is disposed in between the first spacer half 148 and the second spacer half 150. The first and second spacer halves 148, 150 may be made of different materials. For example, the first spacer half 148 may be made of an insulating material to reduce heat loss to the ambient air and the second spacer half 150 may be made of a material that facilitates heat transfer between the heating element 152 and outer cells 136, 138. The heating element 152 may be a heat film as described above.

Alternatively, the endplate spacer 146 is the heating element. Rather than having two spacer halves sandwiching a heating element, the spacer 146 is of uniform construction and has an electric coil embedded within the spacer 146. The electric coil is connected to a current source and generates heat as current passes through the electric coil. In another alternative, the heating element 152 is the endplate spacer. Here, the heating element includes additional structure to separate the stack 134 and the endplates. For example, the heating element may include a thermally conductive side disposed against the stack 134 and a thermally insulated side disposed against the endplates 144.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A traction battery assembly comprising:
a battery stack including a first cell defining one end of the stack;
an endplate disposed proximate the first cell; and
an insulator body disposed between the endplate and the first cell, wherein the insulator body thermally insulates the first cell from the endplate to reduce dissipation of cell-generated heat and to facilitate cell stack warm up in cold conditions.

2. The traction battery of claim 1 further comprising a thermal plate supporting the battery stack and configured to thermally regulate temperature of stack.

3. The traction battery assembly of claim 1 wherein the battery stack further comprises a plurality of interior cells separated by spacers.

4. The traction battery of claim 1 wherein the insulator body further comprises a heating element disposed on a cell facing side of the insulator body.

5. The traction battery of claim 1 further comprising a heating element disposed against the first cell.

6. The traction battery of claim 5 wherein the heating element further comprises a plastic film and an electric heating coil disposed within the film.

7. A traction battery assembly comprising:
a plurality of battery cells defining a battery stack;
a pair of endplates disposed against opposing ends of the stack and configured to apply compression to secure the stack together; and
a pair of insulator bodies, each disposed against opposite sides of the stack between an outer cell of the stack and one of the endplates to thermally insulate the stack from the endplate to reduce dissipation of cell-generated heat and to facilitate cell stack warm up in cold conditions.

8. The traction battery assembly of claim 7 wherein the insulator bodies include polypropylene, high density polyethylene, polyamide, nylon, polyphenylene oxide or polybutylene terephthalate.

9. The traction battery assembly of claim 7 wherein the battery stack further comprises a plurality of cell spacers disposed between the plurality of cells in the stack.

10. The traction battery assembly of claim 7 further comprising a pair of heating elements, each heating element being disposed between the stack and one of the insulator bodies.

11. The traction battery assembly of claim 7 wherein the insulator bodies each include a heating element.

12. The traction battery assembly of claim 10 wherein the heating elements are an electric heating element.

13. The traction battery assembly of claim 10 wherein each heating element further comprises a plastic film and an electric heating coil disposed within the film.

14. A traction battery assembly comprising:
a battery stack including a first cell defining one end of the stack;
an endplate disposed proximate the first cell; and
a heating element disposed adjacent to a major surface of the first cell to provide thermal energy to the battery stack.

15. The traction battery assembly of claim 14 wherein the heating element is disposed between the endplate and the first cell.

16. The traction battery assembly of claim 14 wherein the heating element includes a thermally conductive surface disposed against the major surface of the first cell and a thermally insulated surface opposite the thermally conductive surface.

17. The traction battery assembly of claim 16 wherein the thermally insulated surface is disposed against the endplate.

18. The traction battery assembly of claim 14 wherein the heating element is laminated to the first cell.

19. The traction battery assembly of claim 14 wherein the heating element is an electric heating element.

20. The traction battery assembly of claim 14 wherein the heating element further comprises a plastic film and an electric heating coil disposed within the film.
